(19) United States
(12) Patent Application Publication
(10) Pub. No.: US 2026/0316722 A1
(43) Pub. Date: Oct. 15, 2026

(54) ADHESIVE REMOVAL TOOL

(71) Applicant: Ingersoll-Rand Industrial U.S., Inc., Davidson, NC (US)

(72) Inventors: Joshua O. Johnson, Allentown, PA (US); Qi Zhu, Shanghai (CN); Tyler Laubach, Allentown, PA (US)

(21) Appl. No.: 19/178,166

(22) Filed: Apr. 14, 2025

(51) Int. Cl. B60S 3/04

(52) U.S. Cl. CPC B60S 3/048

(57) ABSTRACT

A adhesive removal tool driving an eraser wheel for removing adhesives. The adhesive removal tool including an elongated housing that extends along a longitudinal axis, an electric motor disposed within the housing, a gearbox coupled to the electric motor, a spindle coupled to the gearbox and configured rotate about the longitudinal axis and to receive an eraser wheel, a switch that operatively controls the electric motor, a biased trigger operatively coupled to the switch, and a battery for supplying power to the electric motor. The battery has an elongated housing that defines a battery axis, wherein the battery axis forms an angle with the longitudinal axis.

### BACKGROUND

Eraser wheels are widely used in automotive detailing and repair to remove adhesive-backed materials such as vinyl decals, pinstripes, and trim tape from vehicle surfaces. In some instances, eraser wheels are used to remove adhesive left behind on a vehicle wheel rim from a removed wheel weight. These eraser wheels, typically made of rubber or polymer, rely on rotational motion to generate friction, lifting adhesive material without damaging the underlying paint.

### BRIEF DESCRIPTION OF THE DRAWINGS

The Detailed Description is described with reference to the accompanying figures. The accompanying figures, where like reference numerals, refer to identical or functionally similar elements throughout the separate views and which, together with the detailed description below, are incorporated in and form part of the specification, serve to further illustrate various embodiments and to explain various principles and advantages all in accordance with the systems and methods disclosed herein.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the systems and methods disclosed herein.

FIG. 1 is a perspective view of an adhesive removal tool in accordance with an example embodiment of the present disclosure.

FIG. 2 is a side elevation cross-section view of the adhesive removal tool of FIG. 1.

### DETAILED DESCRIPTION

Aspects of the disclosure are described more fully hereinafter with reference to the accompanying drawings, which form a part hereof, and which show, by way of illustration, example features. The features can, however, be embodied in many different forms and should not be construed as limited to the combinations set forth herein; rather, these combinations are provided so that this disclosure will be thorough and complete and will fully convey the scope.

### Overview

Pneumatic drivers are the most common tool used to drive eraser wheels; however, these pneumatic drivers require a compressed air system, which adds to further equipment costs. Moreover, tethered pneumatic and corded electric drivers require a tethered air hose or electrical supply cord, which presents a tripping hazard within busy workspaces and further limits the tool’s mobility to the length of the hose or cord.

Another difficulty is that electric and pneumatic driver tools typically have a pistol grip that offers a practical and ergonomic grip for fastening operations or other operations in which the user applies a moderate force against a workpiece along a rotating axis of the tool. However, for eraser wheels, the working surface of the tool is along a rotating circumference of the eraser wheel instead of along the axis of rotation. This orientation makes such pistol grip tools awkward and impractical for the user since the user must apply a force that is radial to the rotating axis of the tool, presenting both a tool instability problem and providing limited working angles of the eraser wheel due to the geometry of the pistol grip tool. Moreover, the combined arrangement of a pistol grip tool with an eraser wheel makes working within confined spaces, such as within a wheel rim, difficult since the geometry of the driver tool often interferes with the workpiece. As a result, eraser wheels driven by pistol grip drive tools must be replaced and sometimes discarded early despite the eraser wheel having sufficient, although inaccessible, eraser material due to the limited working angles of the pistol grip drive tool. Ideally, the eraser wheel should be worn down as close as possible to its axis of rotation before the driver tool and/or the user’s hands interfere.

Considering these difficulties, several solutions have been considered but offer limited success. One solution to overcome teathered pneumatic or corded electrical systems is to provide a battery-operated driver tool. This solution, however, comes at the cost of increased tool size since the power supplied to the driver tool is localized into a battery that is either housed within the driver tool housing or attached to the driver tool through a battery dock, and the location of the battery often interferes with the user or the workpiece being worked upon.

Another solution is to avoid the pistol grip configuration by elongating the handle of the driver tool along the rotational axis of the tool and position the battery within the elongated handle. However, this solution creates several limiting factors in the ability and effectiveness of the driver tool, such as lengthening the tool, and creating tool balance issues. Batteries are rated based on their deliverable voltage and charge capacity, with voltage being proportional to the power output of the driver tool, and charge capacity (i.e., amp-hours) being proportional to the length of time that the battery can supply an electrical current to the driver tool. For driver tools, both voltage and charge capacity are desired to provide adequate torque output and lifetime before battery replacement or recharging is needed. However, greater voltage and charge capacity come at the cost of battery volume, which adds to the size and weight of the driver tool. Although it is possible to elongate the length of the handle to accommodate any size battery capacity, doing so is not always desirable as it can make the driver tool cumbersome (i.e., unfit for confined spaces) and unbalanced (i.e., the extended length and weight of the battery generates a greater moment arm on the driver tool, making it difficult for a user to wield with one hand). Therefore, a battery-powered driver tool for an eraser wheel is desired that allows for a wide range of workable tool angles without sacrificing battery size, power, or capacity.

Another problem is the operational speed of the driver tool. Users operating adhesive removal tools generally prefer speeds that do not overheat the underlying painted surfaces. However, pneumatic driver tools typically offer only one speed, which depends on a supplied air pressure and a compressed air regulator that requires frequent manual adjustments. This single speed forces the user to carefully pulse or “feather” the driver tool so that the tool speed is within the desired rotational speed range (revolutions per minute (RPM)), which can be difficult for an unskilled user to manage. Depending on the material of the workpiece, different RPMs are desired for the driver tool. For example, when working with painted metal, the driver tool can operate within 0-3700 RPM, but painted plastic has a lower heat tolerance, so the driver tool should operate within 0-1250 RPM to prevent overheating. Therefore, a driver tool that offers selectable speed ranges is desired.

As disclosed herein, embodiments of a cordless adhesive removal tool, i.e., a battery powered tool configured to drive an eraser wheel for removing adhesive material, are illustrated and described. Embodiments of the adhesive removal tool offer a cordless solution via a battery that provides tetherless convenience and mobility. Moreover, the adhesive removal tool employs a battery that forms an angle relative to a longitudinal axis of the adhesive removal tool such that the angle allows for the battery to not structurally interfere with a workpiece and/or the user during adhesive removal. The angled battery orientation further provides improved workable angles for an attached eraser wheel for use inside wheel rims and along flat and curved body panels. Angling the battery also helps to shorten the tool length while not interfering with a user’s hand/arm during vertical and horizontal use cases. Furthermore, arranging a handle of the tool to extend along an axis of rotation provides improved user control for applying pressure along the circumference of an eraser wheel, unlike a pistol grip configuration in which the tool handle extends perpendicular to an axis of rotation of an output drive of the tool.

The adhesive removal tool includes a two-speed selector to allow more control by limiting the overall max rotational speed of the tool, with a low-speed setting that limits the speed to 0-1250 RPM, and a high-speed setting that limits the speed to 0-3700 RPM. This selection capability allows high-speed work when needed for painted metal and low-speed work when needed on painted plastic so that the paint is not removed from the substrate due to overheating. Moreover, the two-speed selector allows for more control with less fatigue as the user does not have to adjust an air regulator or hold a throttle lever in a mid position for lengths of time.

### DETAILED DESCRIPTION OF EXAMPLE EMBODIMENTS

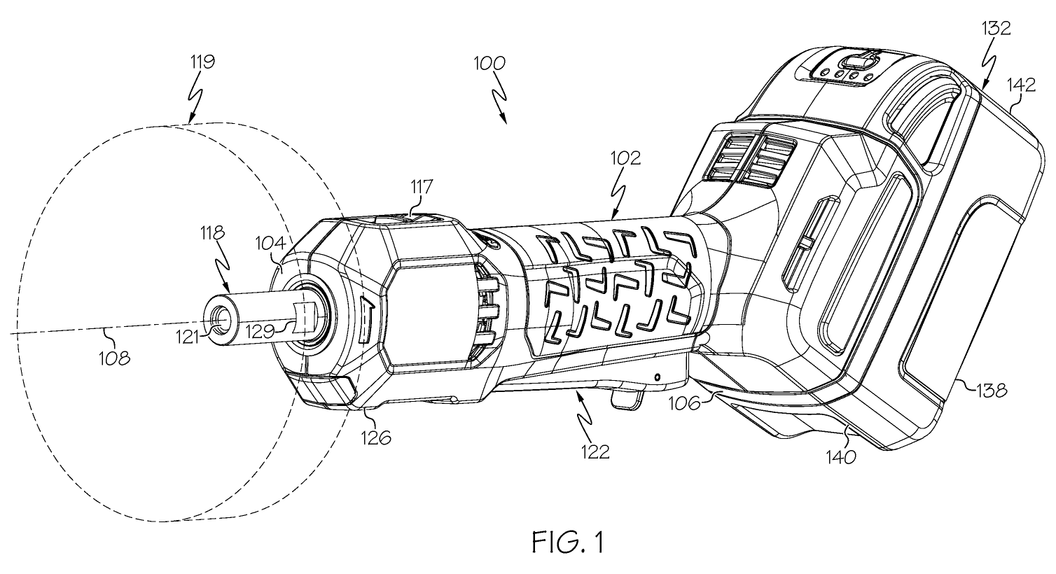

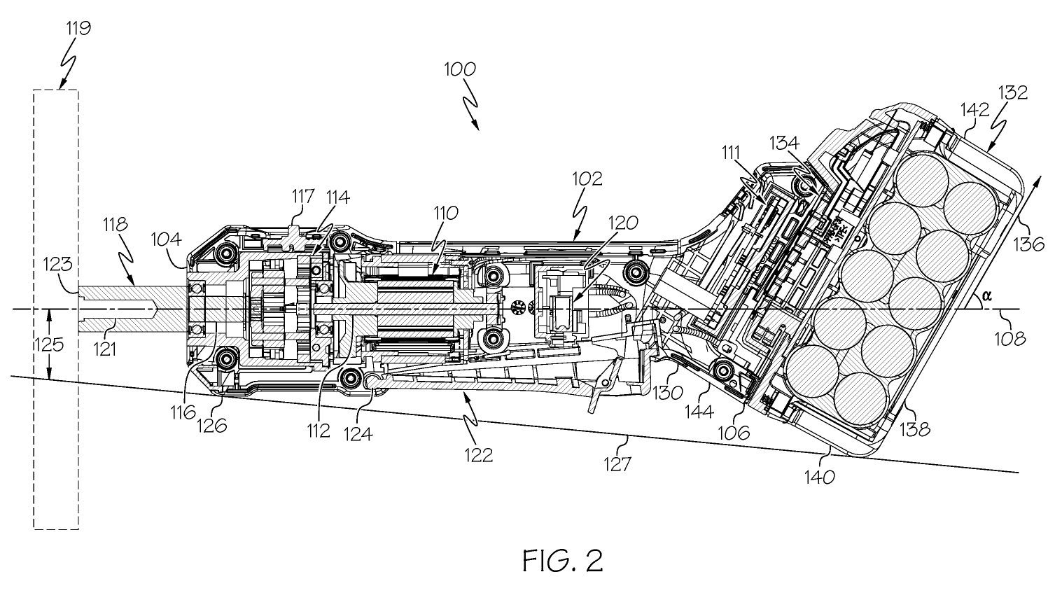

Referring to FIGS. 1 and 2, a adhesive removal tool 100 for driving an eraser wheel is described. In general, adhesive removal tool 100 includes an elongated housing 102 having a first end 104 and a second end 106 such that the second end 106 is opposite to the first end 104. As described, the elongated housing 102 extends along a longitudinal axis 108.

As described, the adhesive removal tool 100 includes an electric motor 110 that is disposed within the housing 102 and includes a motor output 112 configured to rotate about the longitudinal axis 108. Moreover, a gearbox 114 is disposed within the housing 102 and is coupled to the motor output 112, which further includes an output drive 116. In general, the gearbox 114 is configured to receive rotational motion from the motor output 112 and to output a converted rotational motion at the output drive 116 via a gearing system coupled between the motor output 112 and the output drive 116 within the gearbox 114. In embodiments, the gearing system has a gear ratio that provides a mechanical advantage to the output drive 116 relative to the motor output 112. In embodiments, the gearbox 114 includes a planetary gear set (i.e., epicyclic gear train) that converts rotations from the motor output 112 to the output drive 116. In embodiments, the gearbox 114 is a two-speed gearbox that is operatively controlled by a gear switch 117 that, while in a first position, the gearbox has a first gear ratio, and in a second position, the gearbox has a second gear ratio. In embodiments, the electric motor 110 outputs a maximum speed that remains substantially constant (i.e., after initial energizing of the electric motor 110 in which the motor spools up to a maximum rotational speed, the electric motor 110 maintains the maximum rotational speed while energized). In embodiments, the first gear ratio of the gearbox 114 receives a rotational speed from the electric motor 110 and outputs a rotational speed at the output drive 116 to a range of 0-1250 RPM. In embodiments, the second gear ratio of the gearbox 114 receives a rotational speed from the electric motor 110 and outputs a rotational speed at the output drive 116 to a range of 0-3700 RPM.

As described, the adhesive removal tool 100 includes a spindle 118 coupled to the output drive 116 external to housing 102, and located proximate to and extending from the first end 104 of housing 102. In general, the spindle 118 rotates about the longitudinal axis 108. The spindle 118 is configured to receive an eraser wheel 119. In embodiments, the spindle 118 includes a threaded hole 121 located at a distal end 123 of the spindle 118 for receiving a fastener that couples the eraser wheel 119 to the spindle 118. In a further embodiment, the threaded hole 121 is a 5/16”-24 threaded hole.

In general, a minimum effective radii 125 of the eraser wheel is limited by a length of the spindle 118 along the longitudinal axis 108 and a distance from the longitudinal axis 108 to the periphery of the housing 102. Greater lengths of the spindle 118 and smaller distances of the periphery of the housing 102 from the longitudinal axis 108 permit use of eraser wheels 119 with proportionally smaller minimum effective radii 125. Such configuation allows the eraser wheel 119 to last, and provide effective removal of adhesive material, for more prolonged use before needing replacement. For example, in FIG. 2, planar surface 127 represents a surface of a workpiece (e.g., a car panel) that the adhesive removal tool 100 may contact while remaining at a useful operational angle of the eraser wheel 119. Thus, the closer the periphery of the housing 102 is to the longitudinal axis 108, the closer the surface 127 can approach the longitudinal axis 108, therefore allowing a smaller minimum effective radii 125. Moreover, the longer the spindle 118 extends along the longitudinal axis 108, the smaller the minimum effective radii 125. However, having too long of a spindle 118 can cause the spindle 118 to bend away from the longitudinal axis 108.

In the embodiment shown, the spindle 118 includes at least two opposing flat surfaces 129 relative to the longitudinal axis 108 for receiving a clamping tool (e.g., a wrench) locking rotation of the spindle 118 for installation or removal of the eraser wheel 119. In another embodiment, the adhesive removal tool 100 includes a spindle lock that rotationally locks the spindle 118 relative to the housing 102.

The adhesive removal tool 100 further includes a switch 120 operatively coupled to the electric motor 110 for selectively controlling electrical power to the electric motor 110. In embodiments, the adhesive removal tool 100 includes a controller 111 that is in electrical communication with the battery 132, switch 120, and electric motor 110. In this embodiment, the controller 111 controls electrical power supplied to the electric motor 110 from the battery 132 based on an actuation of the switch 120.

In a further embodiment, the adhesive removal tool 100 includes a biased trigger 122 that is operatively coupled to the switch 120. In this embodiment, the switch 120 is disposed within the housing 102 while the biased trigger 122 is substantially external to the housing 102 that a user contacts and operates. The biased trigger 122 is configured to pivot with respect to the housing 102 when the trigger 122 is pressed. The trigger 122 is biased by a spring that is coupled between the housing 102 and the trigger 122 such that the trigger 122 is biased away from the housing 102. As described, the biased trigger 122 is configured such that the trigger 122 resists pressing actions by a user such that, when the user presses the biased trigger 122, the switch 120 coupled to the biased trigger 122 is activated and subsequently supplies electrical power to the electric motor 110; and when the user releases the biased trigger 122, the switch 120 is deactivated and subsequently ceases the supplied electrical power to the electric motor 110.

The biased trigger 122 further includes a pin 124 for pivotally coupling the trigger 122 to the elongated housing 102. In embodiments, the pin 124 of the trigger 122 is proximate to the first end 104 of the elongated housing 102. In other embodiments, pin 124 of the trigger 122 is proximate to the second end 106 of the elongated housing 102. In an embodiment, the pin 124 constrains actuation of the trigger 122 to a motion that is substantially transverse to the longitudinal axis 108.

As described, the adhesive removal tool 100 includes a battery 132 located at the second end 106 that supplies power to the electric motor 110. In some embodiments, the adhesive removal tool 100 includes a battery dock 134 configured to receive the battery 132 such that the battery 132 is removably coupled to the battery dock 134, and while coupled together, the battery 132 supplies power to the battery dock 134, which in turn supplies the electrical power to the electric motor 110. As described, the battery 132 has an elongated housing that extends along and defines a battery axis 136. In embodiments, the battery axis 136 is defined by a distal surface 138 of the battery 132 such that the distal surface 138 is opposite from the first end 104 of the elongated housing 102.

In embodiments, the battery dock 134 and/or the battery 132 is oriented such that the battery axis 136 forms an angle α with the longitudinal axis 108. In general, the angle is selected to reduce contact between the battery, a workpiece surface, and a user operating the adhesive removal tool 100 while the longitudinal axis 108 is generally parallel to or tangential with the workpiece surface. In embodiments, the angle α can be any angle such that the battery axis 136 is not parallel to the longitudinal axis 108. Thus, in this embodiment, the angle α can be equal to or less than ninety degrees (90^{o}) and greater than zero degrees (0^{o}). For example, the angle α can be, but is not limited to, seventy-five degrees (75^{o}), sixty degrees (60^{o}), forty-five degrees (45^{o}), thirty degrees (30^{o}), etc. In other embodiments, the angle α is zero degrees (0^{o}), that is, the battery axis 136 extends along (i.e., parallel) the longitudinal axis 108. Thus, in general, the angle α can be ninety degrees (90^{o}), zero degrees (0^{o}), or any angle between.

In embodiments, the battery 132 further includes a proximate battery surface 140 and a distal battery surface 142 such that the proximate battery surface 140 is proximate to the trigger 122 and the distal battery surface 142 is distal from the trigger 122 and opposite from the proximate battery surface 140. In embodiments, the proximate battery surface 140 is flush or tangent to a surface 144 of the elongated housing 102.

In embodiments, the adhesive removal tool 100 includes a protrusion 126 disposed on the elongated housing 102. In these embodiments, the protrusion includes a planar surface configured to support the housing 102 when the adhesive removal tool 100 is placed on a flat surface 127. In this manner, the planar surface of the protrusion causes the adhesive removal tool 100 to resist tipping over while the tool is resting on the flat surface 127. In embodiments, the protrusion 126 is located proximate to the trigger. In further embodiments, the protrusion 126 is proximate to the pin 124 of the trigger 122. In embodiments, the protrusion 126 (proximate to the pin 124 of the 122), the housing 102, and the battery 132 together form a concave surface 130, and the trigger 122 is located on the concave surface 130. In this manner, the trigger 122 is located within a cavity defined by the concave surface 130. Thus, when the protrusion 126 and the battery 132 are in contact with the flat surface 128 when the adhesive removal tool 100 is placed on the flat surface, the trigger 122 is not depressed nor in contact with the surface 127, and therefore reduces accidental activation of the adhesive removal tool 100.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the preceding description, it is understood that terms such as “first,” “second,” “top,” “bottom,” “up,” “down,” and the like, are words of convenience and are not to be construed as limiting terms.

In reading the claims, it is intended that when words such as “a,” “an,” “at least one,” or “at least one portion” are used, there is no intention to limit the claim to only one item unless specifically stated to the contrary in the claim. When the language “at least a portion” and/or “a portion” is used, the item can include a portion and/or the entire item unless specifically stated to the contrary. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

What is claimed is:

1. An adhesive removal tool for driving an eraser wheel for removing adhesive material, the adhesive removal tool comprising:
an elongated housing having a first end and a second end, the second end opposite to the first end, the elongated housing extending along a longitudinal axis and including a battery dock located at the second end;
an electric motor disposed within the housing, the electric motor including a motor output configured to rotate about the longitudinal axis;
a gearbox disposed within the housing and coupled to the motor output, the gearbox including an output drive;
an elongated spindle coupled to the output drive, the spindle extending from the elongated housing along the longitudinal axis, the spindle configured to receive the eraser wheel, the spindle located proximate to the first end of the elongated housing;
a switch operatively coupled to the electric motor for selectively controlling electrical power to the electric motor, the switch in electrical communication with the battery dock;
a biased trigger operatively coupled to the switch, the trigger configured to pivot with respect to the housing when the trigger is pressed; and
a battery removably coupled to the battery dock for supplying power to the battery dock when the battery is coupled to the battery dock, the battery having an elongated housing defining a battery axis,
wherein the battery dock is oriented so that the battery axis forms an angle with the longitudinal axis when the battery is coupled to the battery dock.

2. The adhesive removal tool of claim 1, wherein the angle is selected to reduce contact between the battery and a workpiece surface while the longitudinal axis of the housing is generally parallel or tangential with the workpiece surface.

3. The adhesive removal tool of claim 2, wherein the angle is one of ninety degrees (90^{o}), zero degrees (0^{o}), or any angle therebetween.

4. The adhesive removal tool of claim 1, wherein the battery axis is defined by a distal surface of the battery, and wherein the distal surface is opposite from the first end of the elongated housing when the battery is coupled to the battery dock.

5. The adhesive removal tool of claim 1, wherein the trigger comprises a pin for pivotally coupling the trigger to the elongated housing, the pin of the trigger being proximate to the first end of the elongated housing.

6. The adhesive removal tool of claim 1, wherein the gearbox is a two-speed gearbox having a low-speed and a high-speed setting, the low-speed limiting the adhesive removal tool to 0-1250 RPM, the high-speed limiting the adhesive removal tool to 0-3700 RPM.

7. The adhesive removal tool of claim 1, further comprising a protrusion disposed on the elongated housing, the protrusion including a planar surface configured to support the housing when the adhesive removal tool is placed on a flat surface, wherein the planar surface is configured to resist tipping over adhesive removal tool while the adhesive removal tool is resting on the flat surface.

8. The adhesive removal tool of claim 7, wherein the protrusion is configured to prevent contact between a trigger and the flat surface while the adhesive removal tool is resting on the flat surface.

9. The adhesive removal tool of claim 1, wherein the elongated battery further comprises a proximate trigger surface and a distal trigger surface such that the proximate trigger surface is proximate to the trigger and the distal trigger surface is distal from the trigger and opposite from the proximate trigger surface, wherein the proximate trigger surface is flush or tangent to a surface of the elongated housing.

10. A adhesive removal tool for driving an eraser wheel for removing adhesive material, the adhesive removal tool comprising:
an elongated housing having a first end and a second end, the second end opposite to the first end, the elongated housing extending along a longitudinal axis and including a battery dock located at the second end;
an electric motor disposed within the housing, the electric motor including a motor output configured to rotate about the longitudinal axis;
a gearbox disposed within the housing and coupled to the motor output, the gearbox including an output drive;
an elongated spindle coupled to the output drive, the spindle extending from the elongated housing along the longitudinal axis, the spindle configured to receive the eraser wheel, the spindle located proximate to the first end of the elongated housing;
a switch operatively coupled to the electric motor for selectively controlling electrical power to the electric motor, the switch in electrical communication with the battery dock; and
a battery removably coupled to the battery dock for supplying power to the battery dock when the battery is coupled to the battery dock, the battery having an elongated housing defining a battery axis,
wherein the battery dock is oriented so that the battery axis forms an angle with the longitudinal axis when the battery is coupled to the battery dock.

11. The adhesive removal tool of claim 10, wherein the angle is selected to reduce contact between the battery and a workpiece surface while the longitudinal axis of the housing is generally parallel or tangential with the workpiece surface.

12. The adhesive removal tool of claim 11, wherein the angle is one of ninety degrees (90^{o}), zero degrees (0^{o}), or any angle therebetween.

13. The adhesive removal tool of claim 10, wherein the battery axis is defined by a distal surface of the battery, and wherein the distal surface is opposite from the first end of the elongated housing when the battery is coupled to the battery dock.

14. The adhesive removal tool of claim 10, further comprising a biased trigger operatively coupled to the electric motor for selectively controlling electrical power to the electric motor, the trigger in electrical communication with the battery dock, the trigger configured to pivot with respect to the housing when the trigger is pressed, wherein the trigger comprises a pin for pivotally coupling the trigger to the elongated housing, the pin of the trigger being proximate to the first end of the elongated housing.

15. The adhesive removal tool of claim 10, further comprising a biased trigger operatively coupled to the electric motor for selectively controlling electrical power to the electric motor, the trigger in electrical communication with the battery dock, the trigger configured to pivot with respect to the housing when the trigger is pressed, wherein the trigger comprises a pin for pivotally coupling the trigger to the elongated housing, the pin of the trigger being proximate to the second end of the elongated housing.

16. The adhesive removal tool of claim 10, further comprising a protrusion disposed on the elongated housing, the protrusion including a planar surface configured to support the housing when the adhesive removal tool is placed on a flat surface, wherein the planar surface is configured to resist tipping over adhesive removal tool while the adhesive removal tool is resting on the flat surface.

17. The adhesive removal tool of claim 10, wherein the gearbox is a two-speed gearbox having a low-speed and a high-speed setting, the low-speed limiting the adhesive removal tool to 0-1250 RPM, the high-speed limiting the adhesive removal tool to 0-3700 RPM.

18. The adhesive removal tool of claim 10, wherein the elongated battery further comprises a proximate trigger surface and a distal trigger surface such that the proximate trigger surface is proximate to the trigger and the distal trigger surface is distal from a trigger and opposite from the proximate trigger surface, wherein the proximate trigger surface is flush or tangent to a surface of the elongated housing.

19. An adhesive removal tool, comprising:
an elongated housing having a first end and a second end opposite to the first end, the elongated housing extending along a longitudinal axis;
an electric motor disposed within the housing, the electric motor including a motor output configured to rotate about the longitudinal axis;
a gearbox disposed within the housing, the gearbox including an output drive coupled to the motor output; and
a spindle coupled to the output drive and extending from the elongated housing along the longitudinal axis proximate to the first end, the spindle configured to receive an eraser wheel.

20. The adhesive removal tool of claim 19, further comprising:
a battery dock located at the second end, the battery dock configured to receive a battery removably coupled to the battery dock for supplying electrical power to the electric motor, the battery having an elongated housing defining a battery axis, wherein the battery dock is oriented so that the battery axis forms an angle with the longitudinal axis; and
a switch operatively coupled to the electric motor and the battery dock for selectively controlling the supply of electrical power to the electric motor by the battery.
